(19) United States
(12) Patent Application Publication
(10) Pub. No.: US 2019/0136824 A1
(43) Pub. Date: May 9, 2019

(54) ANGLE-ADJUSTABLE TURBINE

(71) Applicant: Delphis M.C. BORLE, Leduc (CA)

(72) Inventor: Delphis M.C. BORLE, Leduc (CA)

(21) Appl. No.: 16/013,174

(22) Filed: Jun. 20, 2018

Related U.S. Application Data
(60) Provisional application No. 62/583,595, filed on Nov. 9, 2017.

(51) Int. Cl. F03B 13/26; F03B 17/06

(52) U.S. Cl. CPC F03B 13/264; F03B 17/06; F05B 2240/60; F05B 2250/711; F05B 2240/932; F05B 2250/232

(57) ABSTRACT

There is provided a turbine with a turbine body, a support frame, and a generator. The turbine body has a plurality of turbine blades, a shaft defining a rotational axis, and a bottom apex. Each of the turbine blades has a lower edge, and the lower edges taper upward relative to the bottom apex such that the lower edges trace a convex surface as the turbine body rotates about the rotational axis. The support frame is connected to the shaft by an angularly adjustable connection that adjusts the angle of the shaft relative to the support frame. The angularly adjustable connection permits rotation of the shaft about the rotational axis, and the generator is powered by the rotation of the shaft.

### TECHNICAL FIELD

This relates to the generation of electrical power, and in particular, to a turbine that is angle-adjustable.

### BACKGROUND

Electrical power can be generated from travelling fluid flows by transferring a portion of the kinetic energy to a mechanical device. This principle is used, for example, in the case of windmills and water wheels. When changing flow conditions are experienced, it may be desirable to alter the orientation of the elements intersecting the flow in order to maximize power generation. UK Patent Application No. GB 2520422 teaches a tidal turbine system that adjusts in response to tidal conditions. US Patent Application No. 2015/0167646 teaches a wind turbine that tilts in response to different wind flow conditions.

### SUMMARY

According to an aspect, there is provided a turbine comprising a turbine body, the turbine body comprising a plurality of turbine blades, the turbine body having a shaft defining a rotational axis, and a bottom apex, each of the turbine blades having a lower edge, the lower edges tapering upward relative to the bottom apex such that the lower edges trace a convex surface as the turbine body rotates about the rotational axis, a support frame connected to the shaft by an angularly adjustable connection that adjusts the angle of the shaft relative to the support frame, the angularly adjustable connection permitting rotation of the shaft about the rotational axis, and a generator powered by the rotation of the shaft.

According to another aspect, the angularly adjustable connection may be actuated by an actuator.

According to another aspect, the angularly adjustable connection may change the orientation of the convex surface traced by the lower edges of the turbine blades.

According to another aspect, the support frame may comprise floats to suspend at least a portion of the support frame above a body of water and the turbine body may extend into the body of water.

According to an aspect, there is provided a method of generating electrical energy from a fluid flow travelling in a flow direction, the method comprising the steps of installing a turbine adjacent to the fluid flow, the turbine comprising a turbine body that extends at least partially into the fluid flow, the turbine body comprising a plurality of turbine blades, the turbine body having a shaft defining a rotational axis, and a bottom apex, the rotational axis being perpendicular to the flow direction of the fluid flow, each of the turbine blades having a lower edge, the lower edges tapering upward relative to the bottom apex such that the lower edges trace a convex surface as the turbine body rotates about the rotational axis, the turbine body being divided by a plane defined by a first axis that is parallel to the flow direction of the fluid flow and the rotational axis of the shaft to define a first side and a second side of the turbine body, a support frame connected to the shaft by an angularly adjustable connection that adjusts the angle of the shaft relative to the support frame, the angularly adjustable connection adjusting the angle of the shaft between a first position where the shaft is vertically oriented and a second position where the shaft is angled from the vertical orientation, the angularly adjustable connection permitting rotation of the shaft about the rotational axis, and a generator powered by the rotation of the shaft, adjusting the angle of the shaft between the first position and the second position to adjust the relative volume of fluid flow that passes along the first side of the turbine body relative to the second side of the turbine body, and collecting electrical energy from the generator.

According to another aspect, the fluid flow may be a body of water.

According to another aspect, the body of water may be an ocean, and the angle of the shaft may be adjusted in response to a changing tide.

According to another aspect, the support frame may comprise floats to suspend at least a portion of the support frame above a body of water and the turbine body may extend into the body of water.

According to another aspect, the angularly adjustable connection may adjust the angle of the shaft between the first position, the second position, and a third position, wherein in the third position the shaft is angled in the opposite direction from the second position relative to the first position.

According to another aspect, the angle of the shaft may be adjusted in response to a change in the fluid flow.

According to another aspect, the angularly adjustable connection may be actuated by an actuator.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation schematic view of a water turbine in a first angular position.

FIG. 2 is a side elevation schematic view of a water turbine in a second angular position.

FIG. 3 is a top plan view of a turbine body.

FIG. 4 is a side elevation view of the turbine body of FIG. 3.

### DETAILED DESCRIPTION

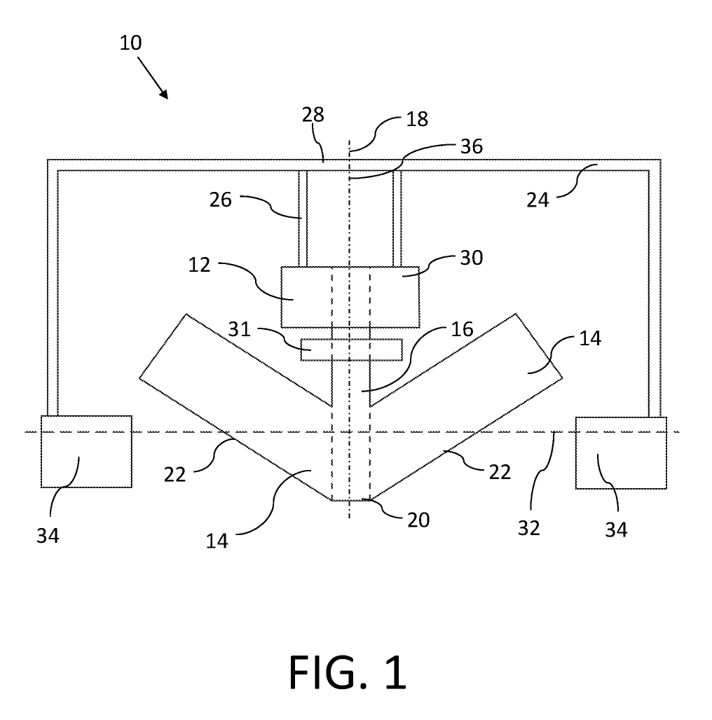

A turbine generally identified by reference numeral 10, will now be described with reference to FIG. 1 through 4.

Referring to FIG. 1, turbine 10 has a turbine body 12 that has a plurality of turbine blades 14. Turbine body 12 has a shaft 16 that rotates about a rotational axis 18. Turbine body 12 also has a bottom apex 20. Each of the turbine blades 14 has a lower edge 22. Lower edges 22 taper upward relative to bottom apex 20 such that, as turbine body 12 rotates about rotational axis 18, lower edges 22 trace a convex surface. As can be seen, lower edges 22, when taken together, are generally cone-shape, although this may be modified as will be discussed below.

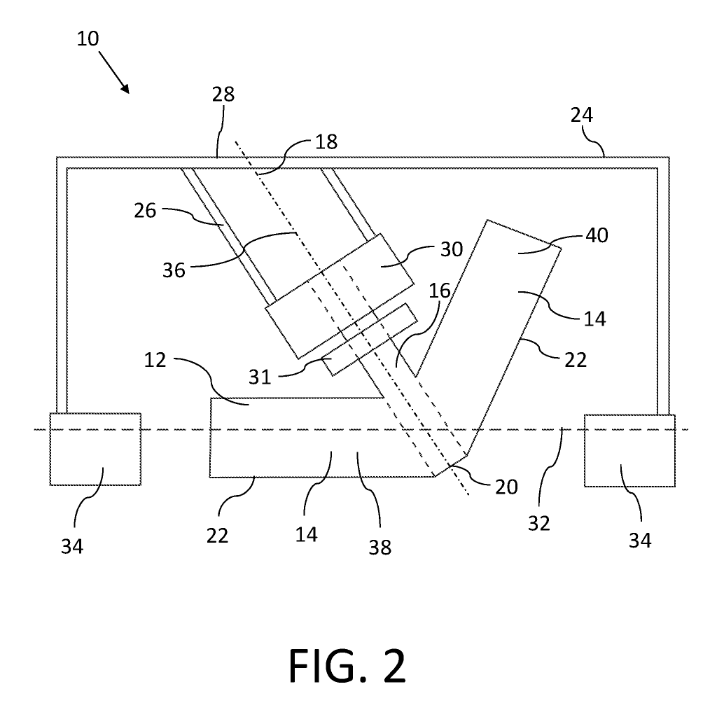

Turbine 10 has a support frame 24 connected to shaft 16 by an angularly adjustable connection 26 that adjusts the angle of shaft 16 relative to support frame 24. Angularly adjustable connection 26 adjusts the orientation of the convex surface traced by lower edges 22 of turbine blades 14, as shown in FIG. 2. Angularly adjustable connection 26 may be actuated by an actuator 28. Angularly adjustable connection 26 permits rotation of shaft 16 about rotational axis 18. Turbine 10 has a generator 30 that is powered by the rotation of shaft 16. Turbine 10 may also have a transmission 31. When used on a body of water 32, such as a tidal body, support frame 24 may have floats 34 that suspend at least a portion of support frame 24 above body of water 32 and allows turbine body 12 to extend into body of water 32.

The manner in which the angle of shaft 16 is adjusted relative to frame 24 may take different shapes. For example, there may be a simple pivot point connection about which shaft 16 pivots to move turbine body 12 from side to side. Alternatively, as this may results in a lateral translation of turbine body 12, which may be undesirable, the connection may be more complex such that turbine body 12 remains in a relatively constant position, such as a connection that slides along support frame 24 as the angle of shaft 16 is adjusted. The connection between shaft 16 and generator 30 may need to be adjustable as well, such as by providing a universal joint, a sliding carriage, a telescopic connection, etc., unless generator 30 is designed to move with shaft 16 as it is adjusted.

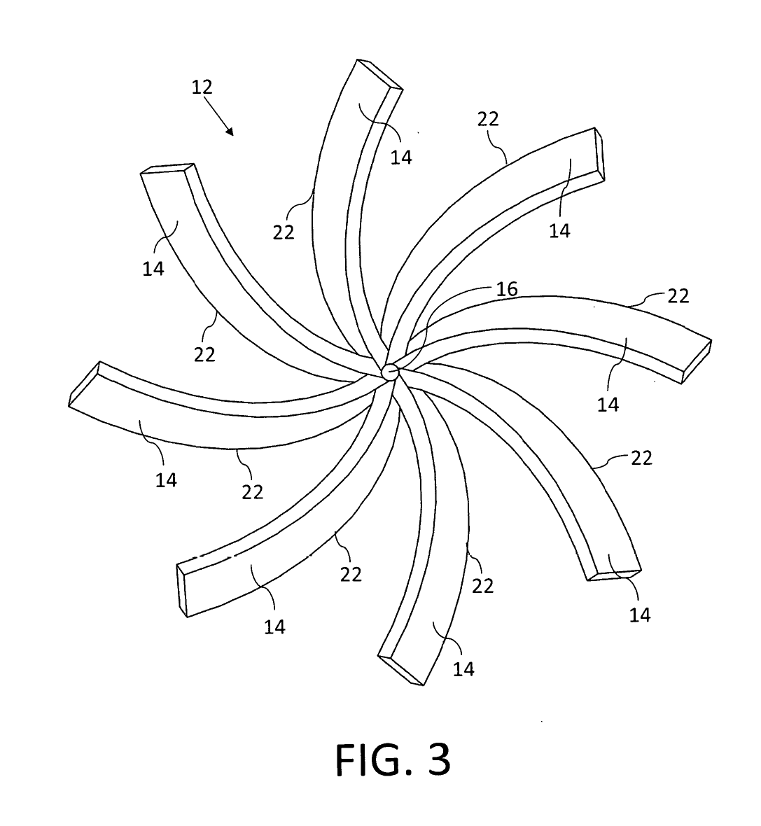

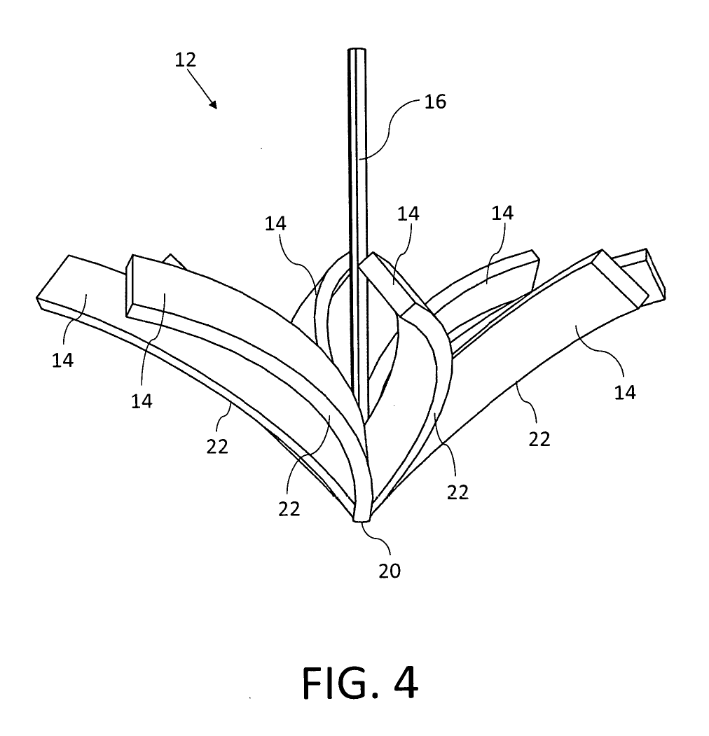

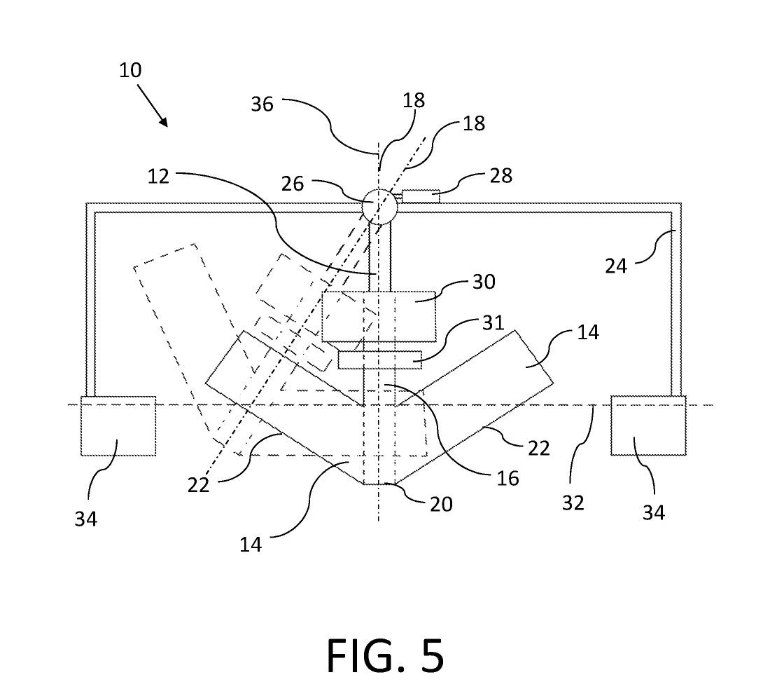

Referring to FIG. 3 and FIG. 4, an embodiment of turbine body 12 is shown. As depicted, turbine blades 14 curve upward and outward from shaft 16. However, it will be understood that a variety of shapes of turbine blades 14 as are known in the art may be used. For example, turbine blades 14 may be curved in only one direction, or may be flat. Turbine blades 14 may be formed to have opposing blades on either side of shaft 16, and other spacing may be used. Blades 14 are angled toward each other in a chevron or angled shape in order to catch the current on one side when turbine body 12 is angled into a fluid flow. Lower edges 22 of turbine blades 14 may have a different profile, such as curves, such that, rather than following a cone-shaped surface, turbine blades 14 follow a semi-spherical or otherwise rounded surface. This allows for the blades 14 on the other side of turbine body 12 to be raised out of the fluid flow, reducing their resistance as they travel around the other side of the turbine body 12 to re-enter the fluid flow. For example, in a stream of water, turbine body 12 may be angled such that the various turbine blades 14 of turbine body 12 enters the water and are pushed by the stream of water. Turbine blades 14 are then lifted out of the stream of water, and are rotated to the front of turbine body 12, i.e. upstream, before re-entering the stream of water. As such, the fluid resistance on turbine blades 14 as they return upstream is reduced. The angle of turbine body 12 may be adjusted to optimize the transfer of kinetic energy to shaft 16, based on the characteristics of the stream of water. Frame 24 may be installed adjacent to the stream of water using various techniques, such as a floating support structure, cable suspension, piles, etc., with the understanding that it will be generally preferred to have turbine body 12 at the top surface of the stream of water. These installation techniques may vary depending on the type of fluid stream, which may be different types of water streams or other fluid flows, and on the situation in which turbine 10.

A method of using turbine 10 to generate electrical energy from a fluid flow travelling in a flow direction will now be described. In general, turbine blades 14 will be contacted by the fluid flow, which will apply a force to turbine blades 14 such that turbine body 12 and shaft 16 will rotate. The rotation of shaft 16 generates electrical energy, which can be collected from generator 30. It will be understood that turbine 10 may be used in a variety of circumstances where a fluid flow is provided. For example, turbine 10 may be used as a wind powered electrical generator. Use of turbine 10 will now be described where the fluid flow is a body of water 32. However, it will be understood that the principles of use in body of water 32 will be similar in other fluid flows, such as in wind streams.

Turbine 10 is installed adjacent to body of water 32 such that turbine body 12 extends least partially into body of water 32. Rotation axis 18 is perpendicular to the flow direction of body of water 32. A plane 36 divides turbine body 12, where plane 36 is defined by a first axis that is parallel to the flow direction, and a second axis that is the rotational axis 18 of the shaft 16. Plane 36 defines a first side 38 and a second side 40 of turbine body 12. Referring to FIG. 1 and FIG. 2, angularly adjustable connection 26 adjusts the angle of shaft 16 relative to support frame 24 between a first position, shown in FIG. 1, where shaft 16 is vertically oriented, and a second position, shown in FIG. 2, where shaft 16 is angled from the vertical orientation. Shaft 16 rotates about rotational axis 18, such that the movement of the flow in body of water 32 continues to turn turbine body 12 in the second position. The angle of shaft 16 can be adjusted between the first position and the second position in order to adjust the relative volume of flowing water that passes along the first side 38 of turbine body 12 relative to second side 40 of turbine body 12. The angle of shaft 16 may adjusted in response to a change in the fluid flow.

Turbine 10 may be used on a variety of types of bodies of water 32. For example, turbine 10 may be installed on a body of water 32 that is an ocean, and the angle of shaft 16 may be adjusted in response to a changing tide. Support frame 24 may have pontoons as floats 34, and may be anchored to the ocean floor, or another anchor point such as the shore or a large vessel. Angularly adjustable connection 26 may adjust the angle of shaft 16 between the first position as shown in FIG. 1, the second position as shown in FIG. 2, and a third position, opposite to that shown in FIG. 2. In the third position shaft 16 is angled in the opposite direction from the second position relative to the first position. The angle of shaft 16 may be such that the turbine 10 is in the second position when the tide moves in, the third position as the tide moves out, and the first position as the tide is changing or when power generation is not required. Alternatively, turbine 10 may be installed on a body of water 32 that has a current in a fixed direction, such as a river. In this case the angle of shaft 16 may be adjusted in response to power demands, or in order to protect the power generation equipment. For example, in high current situations, it may be desired to have a smaller proportion of turbine blades 14 in the water at any given time to prevent damage, while in lower current situations it may be desired to angle turbine blades 14 further into the water in order to maximize power generation.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

1. A turbine comprising:
a turbine body, the turbine body comprising a plurality of turbine blades, the turbine body having a shaft defining a rotational axis, and a bottom apex, each of the turbine blades having a lower edge, the lower edges being contained by a cone-shape that slopes upward relative to the bottom apex such that the lower edges trace a convex surface as the turbine body rotates about the rotational axis, the turbine blades being configured to rotate about the rotational axis of the shaft in response to fluid flow along a flow direction, the rotational axis being perpendicular to the flow direction;
a support frame connected to the shaft by an angularly adjustable connection that adjusts the angle of the shaft relative to the support frame while maintaining the rotational axis perpendicular to the flow direction, the angularly adjustable connection permitting rotation of the shaft about the rotational axis;
an actuator that actuates the angularly adjustable connection; and
a generator powered by the rotation of the shaft.

2. The turbine of claim 1, wherein the angularly adjustable connection changes the orientation of the convex surface traced by the lower edges of the turbine blades.

3. The turbine of claim 1, wherein the support frame comprises floats to suspend at least a portion of the support frame above a body of water and the turbine body extends into the body of water.

4. A method of generating electrical energy from a fluid flow travelling in a flow direction, the method comprising the steps of:
installing a turbine adjacent to the fluid flow, the turbine comprising:
a turbine body that extends at least partially into the fluid flow, the turbine body comprising a plurality of turbine blades, the turbine body having a shaft defining a rotational axis, and a bottom apex, the rotational axis being perpendicular to the flow direction of the fluid flow, each of the turbine blades having a lower edge, the lower edges being contained by a cone-shape that slopes upward relative to the bottom apex such that the lower edges trace a convex surface as the turbine body rotates about the rotational axis in response to the fluid flow, the turbine body being divided by a plane defined by the rotational axis of the shaft and a first axis that is parallel to the flow direction of the fluid flow to define a first side and a second side of the turbine body;
a support frame connected to the shaft by an angularly adjustable connection that adjusts the angle of the shaft relative to the support frame, the angularly adjustable connection adjusting the angle of the shaft between a first position where the shaft is vertically oriented and a second position where the shaft is angled from the vertical orientation, the angularly adjustable connection permitting rotation of the shaft about the rotational axis of the shaft; and
a generator powered by the rotation of the shaft;
activating an actuator to adjust the angle of the shaft between the first position and the second position to adjust the relative volume of fluid flow that passes along the first side of the turbine body relative to the second side of the turbine body; and
collecting electrical energy from the generator.

5. The method of claim 4, wherein the fluid flow is a body of water.

6. The method of claim 5, wherein the body of water is an ocean, and the angle of the shaft is adjusted in response to a changing tide.

7. The method of claim 5, wherein the support frame comprises floats to suspend at least a portion of the support frame above a body of water and the turbine body extends into the body of water.

8. The method of claim 4, wherein the angularly adjustable connection adjusts the angle of the shaft between the first position, the second position, and a third position, wherein in the third position the shaft is angled in the opposite direction from the second position relative to the first position.

9. The method of claim 4, wherein the angle of the shaft is adjusted in response to a change in the fluid flow.

10. The method of claim 4, wherein the angularly adjustable connection angle of the shaft is adjusted about a pivot axis that is parallel to the flow direction of the fluid flow such that the shaft moves perpendicularly to the flow direction as the shaft pivots.

11. The turbine of claim 1, wherein the lower edges of the turbine blades trace a generally cone-shaped surface as the turbine body rotates about the rotational axis.

12. The method of claim 4, wherein the lower edges of the turbine blades trace a generally cone-shaped surface as the turbine body rotates about the rotational axis.

13. The turbine of claim 1, wherein the angularly adjustable connection adjusts the angle of the shaft about a pivot axis that is parallel to the flow direction of the fluid flow.

14. The turbine of claim 1, wherein each of the turbine blades curves upwards and outwards from the shaft.

15. The method of claim 4, wherein each of the turbine blades curves upwards and outwards from the shaft.
